(19) United States
(12) Patent Application Publication
(10) Pub. No.: US 2025/0265499 A1
(43) Pub. Date: Aug. 21, 2025

(54) Method and Apparatus for Feature Extraction of Time Series and Generation of Synthetic Time Series Based on the Extracted Features

(71) Applicant: Robert Bosch GmbH, Stuttgart (DE)

(72) Inventors: Johannes Haug, Rottenburg (DE); Lisa Yuan Wang, Friolzheim (DE); Stefan Patrick Lindt, Ettlingen (DE); Eric Sebastian Schmidt, Moensheim (DE)

(21) Appl. No.: 19/048,938

(22) Filed: Feb. 9, 2025

(30) Foreign Application Priority Data
Feb. 16, 2024 (DE) 10 2024 201 468.0

(51) Int. Cl. G06N 20/00

(52) U.S. Cl. CPC G06N 20/00

(57) ABSTRACT

A method for determining descriptive features of a time series originating from a repeating production process is disclosed. The method initially begins by providing the time series along with a number of nodes and a degree of spline approximation. The nodes serve to define the splines used to approximate the time series. Next, distribution of the nodes occurs over the range of times observed. After the nodes are distributed, the time series is approximated using the splines. Finally, the coefficients of the splines for the nodes are stored as descriptive features.

This application claims priority under 35 U.S.C. § 119 to patent application no. DE 10 2024 201 468.0, filed on Feb. 16, 2024 in Germany, the disclosure of which is incorporated herein by reference in its entirety.

The disclosure relates to a method for determining descriptive features of a time series and using them to generate a synthetic time series that is as realistic as possible.

### BACKGROUND

For time series of repeatable processes, particularly manufacturing processes, descriptive statistics of a time series instance may be extracted as features.

Feature extraction is a known procedure, particularly in the area of machine learning and data analysis, in which relevant features are identified and extracted from raw data. These features are used to create a more informative data set that can be used for various tasks such as classification, predictions, regression, anomaly detection, forecasting, or clusters.

Feature extraction aims to reduce data complexity (often referred to as “data dimensionality”) while retaining as much relevant information as possible. This helps improve the performance and efficiency of machine learning algorithms and simplifies the analysis process.

Generally, a feature is a property that characterizes a data point or sequence of data points. Relevant features have a correlation or influence on the use case of a model.

Manufacturing processes generally tend to deliver time series data with highly unbalanced label distribution. For example, there are typically significantly more processes/parts labeled “OK” than “NOK”. Classification and anomaly detection models trained on such time series often tend to be of the overrepresented class. Time series augmentation is one approach to reducing such imbalances. Known time-series augmentation approaches aim to generate new synthetic time series using specialized Generative Adversarial Networks (GAN) architectures.

However, these methods are very data intensive and they have difficulty replicating the smoothness for the real data. They work primarily well with classical time series that are stationary (after correction for potential drift and seasonality).

A method is proposed that allows extraction of particularly meaningful features from a time series. Thus, it is possible to obtain a low-dimensional representation of a time series instance in which particularly few features are sufficient to represent the time series instance. Depending on the specific use case, it is thus possible to achieve the same downstream performance as with 6 the features according to the disclosure instead of the standard tsfresh settings of 282 relevant features.

Furthermore, the extracted features are explainable, i.e., the essence of the time series may be reconstructed from the features and each feature corresponds to the range of values of the time series at predetermined intervals. If the (tabular) downstream model can generate a score per feature (e.g., local or global feature importance or marginal anomalous scores for each feature), they can be transferred back to the time domain. Because each extracted feature is associated with a spline, and each of these splines covers only a certain range of values, we can also map that score to that range of values. In areas where the spline support overlaps, the scores are aggregated accordingly. Thus, for example, the downstream task of a classification provides a statement as to which areas of the curve have contributed to the classification of the short one.

Furthermore, it is proposed to use the method for generating synthetic time series. Compared to comparable methods, which are mostly based on synthetic time series generation methods based on GANs, the use of the method has the following advantages: Fewer data (even one observation is already sufficient) are needed as a basis. Furthermore, the method is not a black box, and thus is highly interpretable. Furthermore, GANs are often unable to produce realistic-looking time series (or require extensive hyperparameter tuning to achieve realism), whereas the method generates realistic time series.

### SUMMARY

In a first aspect of the disclosure, a method is proposed that adjusts one or more smooth curves as closely as possible to portions of a time series instance and uses the coefficients of these functions as extracted features. In detail, it is proposed to approximate each time series by a linear combination of (base) splines. Splines as such are known and can be used to approximate any continuous function as closely as desired. The coefficients of the splines are the extracted features. This is advantageous because it has been found that these features represent a form of the time series progression very well and are thus meaningful features. It is surprising that this procedure is particularly suitable for time series depicting repetitive processes.

It is noted that the features may be used in addition to the usually known features for time series. Extraction may also generally be performed using a rolling windrow approach to deal with longer, non-repeatable time series.

A time series may be understood to mean a plurality of sensor measurements of a sensor over time, each of which was detected at predetermined points in time. The time series may be a single or multi-dimensional time series. Preferably, the time series has been detected during a repeatable manufacturing process (e.g., a pressing or screwing process). Alternatively, the time series may have been detected from a repeatable physical or chemical process, e.g. vehicle sensor measurements.

In a second aspect of the disclosure, it is proposed that the method of the first aspect of the disclosure be used in order to thereby generate synthetic time series.

First, each time series observed from a real data set is approximated using (base) splines. In so doing, the coefficients of the splines are stored according to the method of the first aspect of the disclosure, which may also be referred to as features according to the first aspect of the disclosure, as well as residuals resulting from the difference between the original time series and the approximation. According to the second aspect of the disclosure, it is proposed to modify coefficients in the coefficient space in order to thereby generate as realistic a time series as possible. A first method of the second aspect of the disclosure is to add random noise to the coefficient. A multivariate normal noise with an expected value of zero and a covariance matrix may be used, wherein the covariance matrix of the noise is proportional to the covariance matrix of the real coefficients. A second method is to use a weighted combination between two closely spaced observed coefficients. Then, according to the first or second method, the modified coefficients are transferred back into the time series space, preferably by converting the coefficients into the splines.

To account for roughness of the time series, the residuals are added to the donor instance from which the original coefficients originate. As a result, the characteristic features of the time series can be preserved while generating new coefficients that detect variations and a roughness.

According to another aspect of the disclosure, a method for generating synthetic time series according to the second aspect of the disclosure is used to extend a training data set of training time series, wherein the extended training data set is used to train a machine learning model.

A method for training a machine learning model for classification or anomaly detection, in particular in production processes, is also provided. The method comprising the steps of: providing an extended training data set of training time series which is extended by synthetically-generated time series according to the present method for generating synthetic time series; training the machine learning model based on the extended training data set; and providing the trained machine learning model for classification or anomaly detection, particularly in production processes.

In the present case, an inference method for classification or anomaly detection, in particular in production processes, is also proposed. The inference method comprises the steps of: providing time series data detected by a sensor; and classifying the provided time series data and/or detecting anomalies in the provided time series data by a presently trained machine learning model.

The present inference method may further be used for the analysis of sensor data. A sensor may thereby detect measurements of the environment in the form of sensor signals. These sensor signals may have a one-dimensional or multi-dimensional time series, for example from a repeatable process (e.g., a pressing or screwing operation).

The present inference method and/or method for generation may be used to detect anomalies in a technical system. For example, synthetic time series may be generated to extend an existing time series data set in order to enlarge and/or make the data set more balanced (e.g., “OK” /“NOK” time series). Training the machine learning model to detect anomalies based on the extended data set results in improved model performance compared to training that occurs based only on the originally detected time series.

In further aspects, the disclosure relates to an apparatus and to a computer program, which are each configured so as to carry out the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. In the drawings:

FIG. 1 schematically illustrates a flowchart of an embodiment of the disclosure;

FIG. 2 schematically illustrates a flowchart of a second embodiment of the disclosure;

FIG. 3 schematically illustrates an apparatus for carrying out the disclosure.

### DETAILED DESCRIPTION

In production environments, many processes detect a measurement over time, i.e., sensor data detected during a production operation is aggregated into a time series. The production operation may be a pressing operation, wherein an applied force, but also other sensor data such as torque, pressure, temperature, angle, etc.) was detected as a time series. These measurement curves often have an expected shape around which the measurements vary. Measurements of NOK parts often show a different shape of the curve. The disclosure may be used to extract features from these time series used in downstream tasks such as classification, regression, clustering, and/or anomaly detection of the produced part.

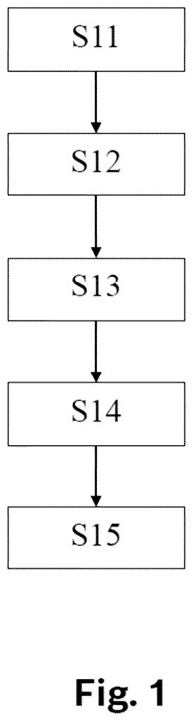

FIG. 1 shows a flow chart of a method for determining meaningful features of a time series. In other words, low-dimensional embeddings of a time series are extracted from the time series. These embeddings can be used for many different downstream tasks by training state-of-the-art tabular machine learning models on these embeddings. However, it is also contemplated that the features are used for a virtual sensor, i.e., based on the features, information about the manufactured product during the detected time series encoded in the features can be determined using a synthetic sensor value.

However, it is also conceivable that the features of the time series are used for classification. For example, the features for locating anomalies in sensor data may be used, wherein the data is classified (e.g., into different failure types).

However, it is also conceivable that the features of the time series are used for a regression. That is to say, the features may be used to determine one or more continuous values, i.e. perform a regression analysis.

However, it is also conceivable that the features of the time series are used for a prediction. In this application, according to a rolling window approach, the features may be used to predict future values of the given time series.

In the following, a method for determining features of repeatable time series instances is presented in FIG. 1. The method also includes the following steps:

selecting (S11) a number of nodes and a max. degree for a spline approximation of the respective time series. The user may specify the number of nodes and the degree to be used for spline approximation.

obtaining (S12) the observed time steps of the time series instances.

distributing (S13) the nodes over the range of observed times to define the splines used. The nodes are preferably uniformly distributed over the range of times observed. These nodes implicitly define the splines used to approximate the time series instances.

Evaluating (S14) all base splines, preferably at each time step observed. This evaluation provides the values of the splines at each time point.

In a preferred development of the method, the following steps can be performed after step S14:

learning (S15) a linear regression. Here, linear regression is learned for a time series, wherein the regression uses the evaluated splines to predict observed value of the time series values as a linear combination of the spline values. The regression parameters learned correspond to the coefficients of spline approximation. That is to say, the coefficient of spline approximation is the coefficient of linear regression. In other words, n base splines are ƒᵢ used. At the time t, the time series value x is described as follows: x=α₁*ƒ₁(t)+ . . . +αₙ*ƒₙ(t).

This formula is determined for all observations x for the respective observation period t. First, the values ƒᵢ(t) are calculated for all time points. Thereafter, the spline coefficients are obtained as a linear regression from the equation above.

Storing the learned regression coefficients as extracted features.

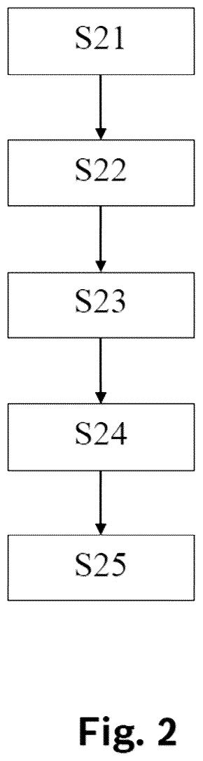

FIG. 2 shows a flow chart of a method for generating synthetic time series. In this way, the method of FIG. 2 may help to obtain a more balanced training set and thus improve generalization capabilities of machine learning systems. The machine learning systems may have been trained for any task. An advantage of this is that the method of FIG. 2 may also be useful to supplement real-world training data sets for which data detection is difficult or expensive.

A particular advantage of the method of FIG. 2 is that it is capable of generating synthetic time series that are based only on a small sample of real time series and is thus very data efficient.

Particularly preferably, the method of FIG. 2 is used to generate synthetic data from a given time series data set to increase its size and/or to make it more balanced (w.r.t., “OK” /“NOK” time series). The training classification model on the extended data set often improves its performance compared to training only on the real-time time series.

In a first embodiment of FIG. 2, generation of one or a plurality of synthetic time series is performed using a modification of coefficients of the splines by way of additive noise.

The method starts with a step S21. Here, one or a plurality of time series is provided as a real data set.

In the following step S22, the following sub-steps are performed for each time series instance of the real data set: extracting the spline coefficients according to the method of FIG. 1 and storing said coefficients.

After step S22, the time series instance is reconstructed again based on the saved coefficients in step S23. Subsequently, a difference between the time series instance and the reconstructed time series is determined by way of the splines; these differences are hereinafter referred to as residuals. Furthermore, in step S23, these residuals are stored for the corresponding coefficients of the time series from the data set.

This is followed by the actual generation of new synthetic time series. In step S24, the following sub-steps are performed for this purpose:

First, a number of the synthetic time series to be generated and optionally a temperature between 0 and 1 is provided.

Generating a noise, wherein the noise is generated from a multivariate normal distribution with an expected value of zero and covariance matrix. The covariance matrix may be calculated as follows: Temperatur×coν(gespeicherteKoeffizienten).

Selecting a “donor instance” from the data set, and thus a set of stored coefficients, and adding the noise to the coefficients.

Retransfer of the coefficients into the time series space as a new synthetic smoothed time series.

Adding the stored residual of the “donor instance” to the new synthetic smoothed time series.

Preferably, step S24 is repeated until the desired number of synthetic time series has been generated.

In a second embodiment of FIG. 2, the coefficients are modified depending on a combination of coefficients of further real time series. For the second embodiment, steps S21 through S23 are the same as for the first embodiment. In contrast, in step S24, the following sub-steps are now performed to generate one or a plurality of new synthetic time series:

To generate synthetic time series, first a number of the time series to be generated and a temperature between 0 and 1 is provided. Then, a “donor instance” is in particular randomly selected from the data set of step S21, and thus its associated set of stored coefficients.

Further donor instances, subsequently called the next neighbor of the initial donor instance, are then determined from the data set. To this end, either a subset of time series can be selected from the entire data set or randomly drawn. Preferably, the neighbors are a subset of the time series. Preferably, the subset is determined depending on the temperature. Then, the corresponding coefficient of one of the nearest neighbors is randomly selected. Then, a random number a between 0.5 and 1 is generated.

The new coefficient is determined by weighting depending on the random number of the coefficient of the donor instance and the randomly drawn coefficient. Preferably, the new coefficient is calculated by the formula α×donor koeffizient+(1−α)×ausgewählter Nachbarkoeffizient.

The coefficients are then retransferred as a new synthetic smoothed time series. To complete the synthetic time series, the stored residual of the donor instance is added to the new synthetic smoothed time series.

Preferably, step S24 is repeated until the desired number of synthetic time series has been generated.

The method of FIG. 2 may be useful wherever a time-series machine learning model suffers from uneven training data. The disclosure is particularly valuable for classification in production processes that provide time series sensor data (e.g. temperature, pressure, force, torque, etc.) with a strong mismatch between “OK” and “NOK” (anomaly) parts. Indeed, classification models tend to miss the subtle differences between “OK” and “NOK” time series when trained primarily on “OK” instances.

In an optional step S25, the generated synthetic time series may be used to be added to a training data set or used to train a machine learning system.

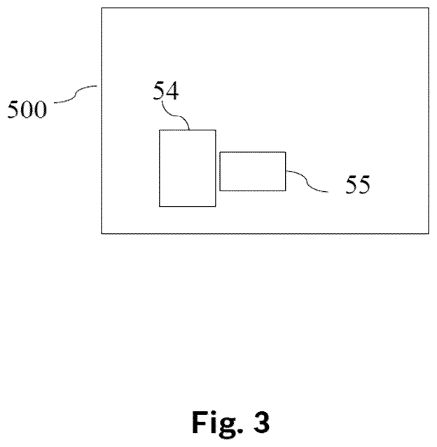

FIG. 3 schematically shows an apparatus 500 for carrying out the method of FIG. 1 or 2. The methods carried out by the apparatus 500 can be stored as a computer program implemented on a machine-readable storage medium 54 and executed by a processor 55.

The term “computer” comprises any device for processing specifiable calculation rules. These calculation rules can be provided in the form of software or in the form of hardware or also in a mixed form of software and hardware.

What is claimed is:

1. A method for determining descriptive features of a time series, wherein the time series has been detected during a repetitive process, comprising:
obtaining the time series and a number of nodes and a degree for spline approximation;
distributing the nodes over the range of the time series;
approximating the time series using splines; and
storing coefficients of the splines for the nodes as descriptive features.

2. The method according to claim 1, wherein a linear regression based on functional values of the splines for the nodes is determined to the detected values of the time series at the respective node and coefficients of regression are stored as the descriptive features.

3. The method according to claim 2, wherein a lasso regression is used.

4. The method according to claim 1, wherein:
the method is used in generating a synthetic time series,
a smoothed time series is reconstructed by splines based on the stored coefficients,
a residual is determined between the obtained time series and the reconstructed time series,
a noise is generated from a multivariate normal distribution,
modified coefficients are determined by adding the noise to the coefficients, and
the synthetic time series is reconstructed from the modified coefficients and the residual is added to the synthetic time series.

5. The method according to claim 4, wherein the noise is determined from a multivariate normal distribution with an expected value of zero and covariance matrix depending on a weighted covariance of stored coefficients of further time series.

6. A method for determining descriptive features of a time series, wherein the time series has been detected during a repetitive process, comprising:
obtaining the time series and a number of nodes and a degree for spline approximation;
distributing the nodes over the range of the time series;
approximating the time series using splines; and
storing coefficients of the splines for the nodes as descriptive features,
wherein the method is used in generating a synthetic time series,
wherein a smoothed time series is reconstructed by splines based on the stored coefficients,
wherein a residual is determined between the obtained time series and the reconstructed time series,
wherein a noise is generated from a multivariate normal distribution,
wherein modified coefficients are determined by adding the noise to the coefficients,
wherein the synthetic time series is reconstructed from the modified coefficients and the residual is added to the synthetic time series,
wherein a data set is provided with a real time series and the coefficients are each stored for all time series of the data set,
wherein coefficients of a first time series are selected,
wherein random coefficients of further time series are selected from the data set and the modified coefficient is determined by a weighted addition of coefficients of the first time series with coefficients of the random time series.

7. The method according to claim 6, wherein the synthetic time series is used to train a machine learning system for classification or anomaly detection.

8. An apparatus which is configured so as to carry out the method according to claim 1.

9. A computer program consisting of instructions which, when the program is executed by a computer, prompt the latter to carry out the method according to claim 1.

10. A machine-readable storage medium on which the computer program according to claim 9 is stored.

11. The method according to claim 1, wherein the repetitive process is a production process.
